(19) United States
(12) Patent Application Publication
(10) Pub. No.: US 2004/0037757 A1
(43) Pub. Date: Feb. 26, 2004

(54) Hydrogen purification apparatus

(76) Inventors: Kiyoshi Taguchi, Osaka (JP); Kunihiro Ukai, Nara (JP); Seiji Fujiwara, Osaka (JP); Takeshi Tomizawa, Nara (JP); Hidenobu Wakita, Kyoto (JP)

Correspondence Address: RatnerPrestia, Suite 301, One Westlakes Berwyn, P O Box 980, Valley Forge, PA, 19482-0980, US

(21) Appl. No.: 10/332,331

(22) PCT Filed: Apr. 26, 2002
(86) PCT No.: PCT/JP02/04229

(30) Foreign Application Priority Data
May 7, 2001 (JP) 2001136625
Jul. 11, 2001 (JP) 2001210427

(51) Int. Cl. B01J 8/04

(52) U.S. Cl. 422/188; 422/211

(57) ABSTRACT

A clarifying catalyst body in an apparatus of hydrogen purification is such that a first catalyst containing at least one kind selected from the group consisting of Pt, Pd, Ru and Rh and a second catalyst containing at least one kind selected from the group consisting of Pd, Ru, Rh and Ni are mixed or integrated, The purifying catalyst body in the apparatus of hydrogen purification consists of (1) an oxide containing at least either Al or Si, (2) at least one kind of transition metal and/or a transition metal oxide and (3) at least one kind of noble metal and/or noble metal oxide selected from the group consisting of Pt, Ru, Pd and Rh.

### TECHNICAL FIELD

The present invention relates to an apparatus of hydrogen purification. More particularly, it relates to an apparatus of removing CO (carbon monoxide) in a reformed gas which contains hydrogen as a main component and carbon monoxide and which is used as a fuel for fuel cells and the like.

### BACKGROUND ART

Fuel-cell cogeneration systems of high power generation efficiency and overall efficiency are attracting attention as distributed power systems which effectively utilize energy.

Many fuel cells, for example, phosphoric acid fuel cells which have been put to practical use and polymer electrolytic fuel cells under development generate power using hydrogen as a fuel. However, because hydrogen is not obtained from infrastructures, it is necessary to generate hydrogen in the places where the systems are installed.

There is a steam reforming process as one of the methods of generating hydrogen. Under this method, a hydrocarbon-based raw material such as natural gas, LPG, naphtha, gasoline and kerosene or an alcohol-based raw material such as methanol is mixed with water, and a steam reforming reaction is caused to occur in a reformer in which a reforming catalyst is provided, whereby hydrogen is generated.

In this steam reforming reaction, carbon monoxide is generated as a by-product component. However, because carbon monoxide deteriorates a fuel-cell electrode catalyst, especially in polymer electrolytic fuel cells, it is necessary to remove carbon monoxide to not more than 100 ppm, preferably to not more than 10 ppm.

Usually, an apparatus of hydrogen purification is provided, behind a reformer to remove the carbon monoxide in hydrogen gas, with a shift converter having a carbon monoxide shifting catalyst body, where a shift reaction is caused to take place between the carbon monoxide in hydrogen gas and steam for conversion to carbon dioxide and hydrogen and the carbon dioxide concentration is lowered to several thousand ppm through about 1%.

Subsequently, hydrogen gas is introduced into a purifying part having a purifying catalyst body, where a selective oxidation reaction is caused to take place between carbon monoxide and oxygen on the purifying catalyst body by feeding air containing oxygen in amounts of 0.5 to 3 times the carbon monoxide concentration. As a result, the carbon monoxide concentration in hydrogen gas is lowered to not more than 10 ppm.

In order to ensure that carbon monoxide is thus reduced to not more than 10 ppm in a stable manner, it is necessary that a high-performance purifying catalyst be provided in the purifying part.

However, usually, hydrogen gas coming from the shift converter contains carbon monoxide in amounts of several thousand parts per million to about 1%. Therefore, in order to reduce carbon monoxide to not more than 10 ppm by use of a purifying catalyst body, it was necessary to set the temperature in a certain range. Even by use of a conventionally used Pt-based catalyst body, it is necessary to control the temperature to a temperature range of about 100° C. to 200° C. or so, and outside this temperature range it was sometimes impossible to lower the carbon monoxide concentration at the outlet of the purifying part to not more than 10 ppm. In order to lower the carbon monoxide concentration to not more than 10 ppm in a stable manner, it was necessary to use a purifying catalyst body capable of reducing carbon monoxide in a wide temperature range.

Also, because in a high temperature region exceeding 200° C., the amount of carbon monoxide formed by a reverse shift reaction in which the carbon dioxide in hydrogen gas and water react was larger than the amount of carbon dioxide reduced by a reaction of carbon dioxide with oxygen, it was necessary to use a purifying catalyst body capable of suppressing the reverse shift reaction in a high temperature region.

Also, because the temperature of the purifying part is low immediately after the start of the apparatus, it was impossible to reduce the carbon monoxide in hydrogen gas by use of the purifying catalyst body. Therefore, it took time to raise the temperature to a level at which the purifying catalyst body can lower the carbon monoxide concentration, and the time from the start of supply of raw material gas to a reforming catalyst until it becomes possible to reduce carbon monoxide to not more than 10 ppm at the outlet of the purifying part, i.e., the startup time was long.

Furthermore, in a case where the flow rate of raw material gas is reduced on the occasion of load variations after the completion of a startup, the heat from the reformer was removed halfway by the heat radiation from the apparatus. As a result, sometimes the temperature of the purifying catalyst body dropped and at that time, it was impossible to lower the carbon monoxide concentration at the outlet of the purifying part to not more than 10 ppm.

Thus, the prior art had the problem that when the temperature of the purifying catalyst body drops, the carbon monoxide concentration at the outlet of the purifying part rises. Also, since it was sometimes impossible to reduce carbon monoxide even by raising the temperature of the purifying catalyst body to high temperatures, it was difficult to control the temperature of the purifying catalyst body so as to ensure a reduction in carbon monoxide.

Furthermore, although it is possible to think about reducing carbon monoxide by introducing much air into the purifying part, hydrogen is also oxidized and consumed. This caused a decrease in reforming efficiency.

### DISCLOSURE OF THE INVENTION

In consideration of such conventional problems as described above, it is an object of the present invention to provide an apparatus of hydrogen purification which is provided with a purifying catalyst body capable of reducing carbon monoxide in a wide temperature range.

Also, it is another object of the present invention to provide an apparatus of hydrogen purification which can shorten the time from the start of supplying a raw material to a reforming catalyst until the carbon monoxide concentration can be lowered to not more than 10 ppm and can ensure a reduction in the carbon monoxide concentration even when the temperature of a purifying catalyst body drops due to load variations etc.

Furthermore; it is further object of the present invention to provide an apparatus of hydrogen purification which suppresses hydrogen consumption caused by the oxidation of hydrogen and improves reforming efficiency.

A 1st invention of the present invention (corresponding to claim 1) is an apparatus of hydrogen purification comprising: a reformed gas supply part which supplies a reformed gas containing hydrogen and carbon monoxide, an oxidizing gas supply part to mix there formed gas supplied from said reformed gas supply part with an oxidizing gas, and a catalyst body through which said reformed gas mixed with oxygen passes, wherein said catalyst body being a substance in which at least two kinds of catalysts having different composition are mixed or integrated.

A 2nd invention of the present invention (corresponding to claim 2) is the apparatus of hydrogen purification according to the 1st invention, wherein said catalyst body is integrated by coating, in layers, a surface of a base material as a catalyst carrier with at least two kinds of catalysts having different compositions.

A 3rd invention of the present invention (corresponding to claim 3) is the apparatus of hydrogen purification according to the 1st or the 2nd invention, wherein said base material as a catalyst carrier is a heat-resisting base material in a honeycomb or pellet shape.

A 4th invention of the present invention (corresponding to claim 4) is the apparatus of hydrogen purification according to any one of the 1st to the 3rd inventions, wherein said catalyst body, a first catalyst containing at least one kind selected from the group consisting of Pt, Pd, Ru and Rh and a second catalyst containing at least one kind selected from the group consisting of Pd, Ru, Rh and Ni are mixed or integrated.

A 5th invention of the present invention (corresponding to claim 5) is the apparatus of hydrogen purification according to any one of the 1st to the 4th inventions, wherein said catalyst body is divided into a plurality of stages and at least between the catalyst bodies is provided a heat radiation part or a cooling part.

A 6th invention of the present invention (corresponding to claim 6) is the apparatus of hydrogen purification according to the 1st invention, wherein

said two kinds or more catalysts are each constituted by one kind or more transition metals and/or transition metal oxides, and at least one kind of noble metals selected from the group consisting of Pt, Ru, Pd and Rh and/or oxides of the noble metals, and

said two kinds or more catalysts, along with a carrier of oxide containing at least either Al or Si, each comprise a first purifying catalyst body.

A 7th invention of the present invention (corresponding to claim 7) is the apparatus of hydrogen purification according to the 6th invention, wherein that said transition metals are first transition metals, Sc, Ti, V, Cr, Mn, Fe, Co, Ni, Cu and Zn.

An 8th invention of the present invention (corresponding to claim 8) is the apparatus of hydrogen purification according to the 6th or the 7th invention, wherein said oxide is zeolite.

A 9th invention of the present invention is the apparatus of hydrogen purification according to the 6th or the 7th invention, wherein said oxide is a cation exchanger.

A 10th invention of the present invention (corresponding to claim 10) is the apparatus of hydrogen purification according to any one of the 6th to the 9th inventions, wherein said first purifying catalyst body is such that said transition metals are carried by said oxide with ion exchange and thereafter at least one kind of noble metals selected from the group consisting of Pt, Ru, Pd and Rh is carried.

An 11th invention of the present invention (corresponding to claim 11) is the apparatus of hydrogen purification according to any one of the 6th to the 11th inventions, wherein the Si/Al ratio of said zeolite is 1 to 100.

A 12th invention of the present invention (corresponding to claim 12) is the apparatus of hydrogen purification according to any one of the 6th to the 11th inventions, wherein said first purifying catalyst body is such that Cu is carried by Y-type zeolite with ion exchange and thereafter Pt is carried.

A 13th invention of the present invention (corresponding to claim 13) is the apparatus of hydrogen purification according to any one of the 6th to the 12th inventions, further comprising a second purifying catalyst body prepared by a metal oxide and a noble metal on the upstream side of said purifying part.

A 14th invention of the present invention (corresponding to claim 14) is the apparatus of hydrogen purification according to the 8th invention, wherein said purifying part is divided into two stages, an upstream second purifying part comprising said second purifying catalyst body and a second oxidizing gas supply part which feeds an oxidizing gas to said second purifying catalyst body, and a downstream first purifying part comprising said first purifying catalyst body and a first oxidizing gas supply part which feeds an oxidizing gas to said first purifying catalyst body.

A 15th invention of the present invention (corresponding to claim 15) is the apparatus of hydrogen purification according to the 9th invention, wherein a temperature detection part is provided in said second purifying part and/or said first purifying part to detect the temperature of said second purifying catalyst body and/or first purifying catalyst body and/or the temperature of said hydrogen gas, and further a reference temperature is set for a temperature detected by said temperature detection part so that when the detected temperature is lower than said reference temperature, said second oxidizing gas supply part is stopped and said first oxidizing gas supply part is operated, and when the detected temperature is not less than said reference temperature, said first oxidizing gas supply part is stopped and said second oxidizing gas supply part is operated.

### BRIEF DESCRIPTION OF THE DRAWINGS

FIG. 1 is a schematic diagram showing the configuration of an apparatus of hydrogen purification related to Embodiment 1 of the invention;

FIG. 2 is a diagram showing the characteristics of a first catalyst and a second catalyst of a carbon monoxide purifying catalyst body used in an apparatus of hydrogen purification related to Embodiment 1 of the invention;

FIG. 3 is a schematic diagram showing the configuration of an apparatus for hydrogen purification related to Embodiment 2 of the invention;

FIG. 4 is a diagram showing the configuration of an apparatus of hydrogen purification in Embodiment 3 of the invention;

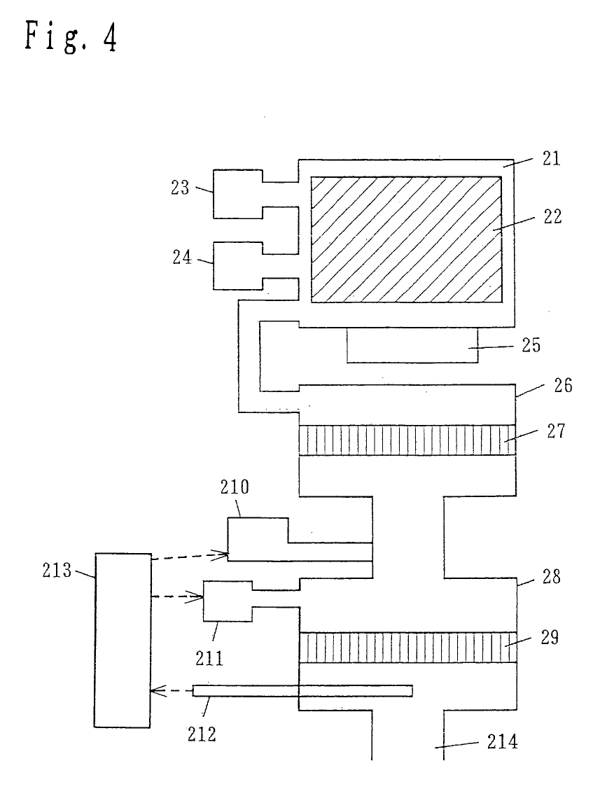

FIG. 5 is a diagram showing the configuration of an apparatus of hydrogen purification in Embodiment 4 of the invention;

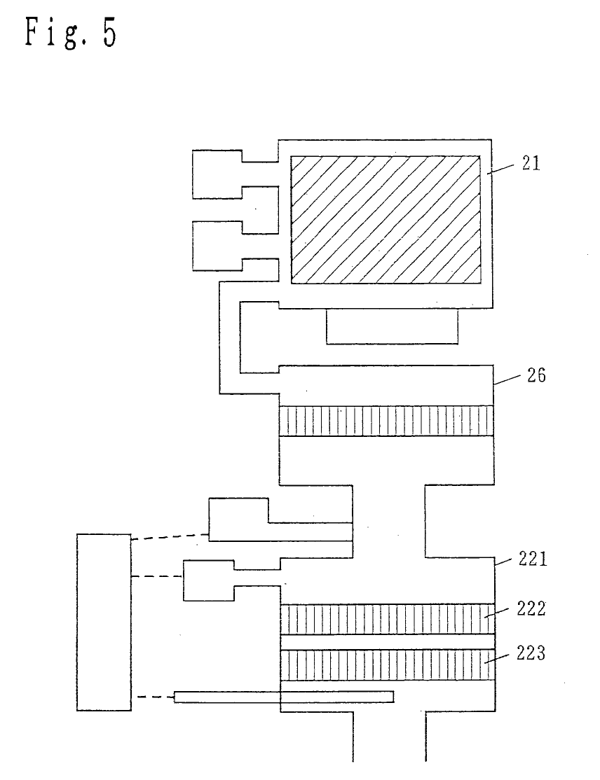

FIG. 6 is a diagram showing the configuration of an apparatus of hydrogen purification in Embodiments 5 and 6 of the invention; and

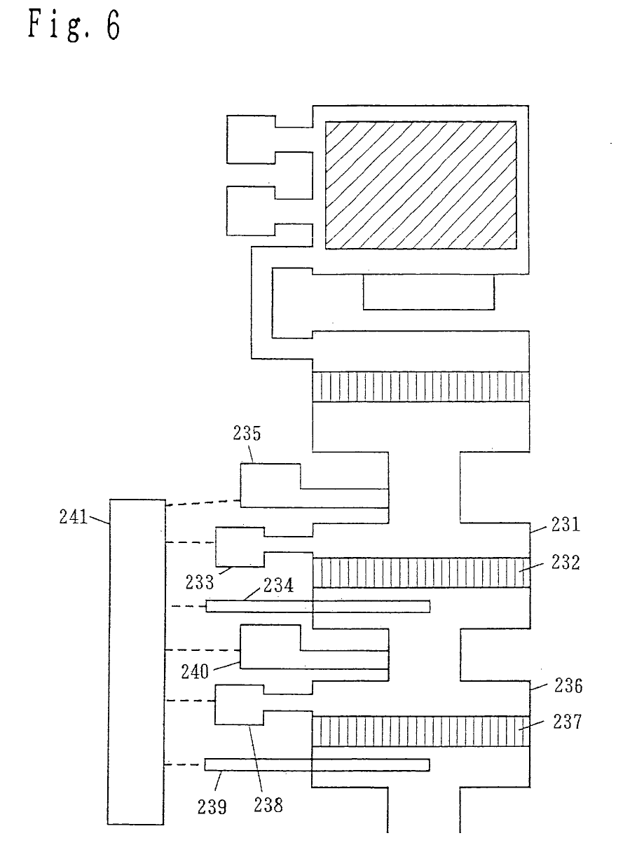

FIG. 7 is a sectional view showing the relationship between a carrier, a transition metal and a noble metal in the embodiments of the invention.

### DESCRIPTION OF SYMBOLS

1 Carbon monoxide purifying catalyst body

2, 13 Reaction chamber

3, 14 Reformed gas inlet

4, 15 Air pump

5, 16 Diffusion plate

6, 17 Reformed gas outlet

7, 18 Heat insulating material

11 First purifying catalyst body

12 Second purifying catalyst body

19 First air supply part

20 Second air supply part

21 Reformer

22 Reforming catalyst

23 Raw material supply part

24 Water supply part

25 Reformer heating part

26 Shift converter

27 Shifting catalyst body

28 Purifying part

29 Purifying catalyst body

125 Reformed gas supply part

210 Cooling fan

211 Air pump

212 Temperature detection part

213 Control part

214 Outlet of purifying part

### BEST MODE FOR CARRYING OUT THE INVENTION

Embodiments of the invention will be described below by referring to the drawings.

In an apparatus for hydrogen purification of the invention, a reformed gas containing hydrogen and carbon monoxide is supplied from a reformed gas supply part and mixed with an oxidizing gas supplied from an oxidizing gas supply part, and then passes through a carbon monoxide purifying catalyst body.

In the carbon monoxide purifying catalyst body, a first catalyst used in a reaction between carbon monoxide and oxygen and a second catalyst used in a reaction between carbon monoxide and hydrogen are made in a composite form. Therefore, carbon monoxide is removed by the oxidation reaction of carbon monoxide by the first catalyst and the methanation reaction of carbon monoxide by the second catalyst.

The reformed gas containing hydrogen and carbon monoxide which is used in the invention is obtained by mixing a hydrocarbon-based fuel, an alcohol-based fuel or an ether-based fuel with steam and air, and causing the mixture to pass first through a heated reforming catalyst body thereby to cause reforming, then through a carbon monoxide shifting catalyst body thereby to cause carbon monoxide to react with hydrogen and lower the carbon monoxide concentration to several thousand parts per million through about several percent by volume.

The composition of a reformed gas after passing through a carbon monoxide shifting catalyst body differs depending on a reforming method and a fuel type. Generally, however, a reformed gas comprises, besides steam, 40 to 80% by volume of hydrogen, 8 to 25% by volume of carbon dioxide and 0.1 to 2% by volume of carbon monoxide. When methane is steam reformed, the reformed gas comprises about 80% by volume of hydrogen, 18 to 20% by volume of carbon dioxide and several thousand ppm to 1% by volume of carbon monoxide. Furthermore, in the case of an alcohol-based fuel or an ether-based fuel that permits a reforming reaction at low temperatures, the carbon monoxide concentration after reforming may sometimes become about 1% by volume and there are cases where a shift reaction by a carbon monoxide shifting catalyst body is not necessary.

Incidentally, such differences in composition will not produce any substantial difference in advantages yielded by the use of an apparatus of hydrogen purification of the invention.

(Embodiment 1)

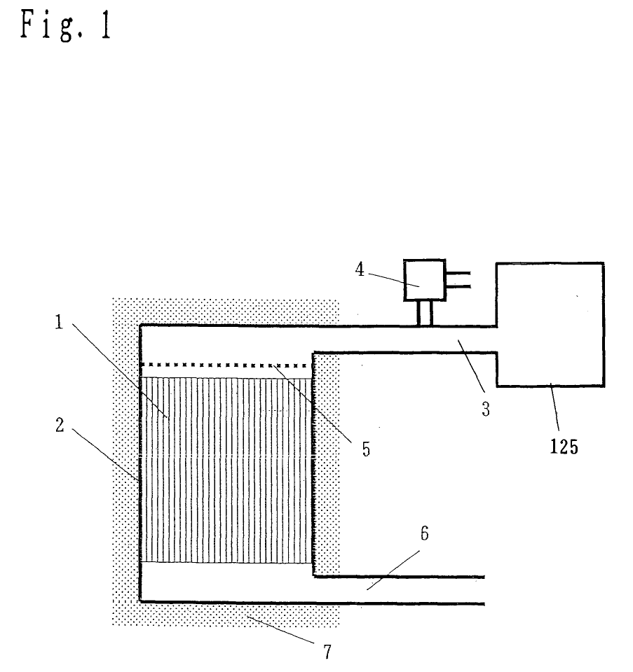

Next, Embodiment 1 of the invention will be described by referring to drawings. FIG. 1 is a schematic diagram showing the configuration of an apparatus of hydrogen purification related to Embodiment 1 of the invention. In FIG. 1, the numeral 1 denotes a carbon monoxide purifying catalyst body which is obtained by coating, on a cordierite honeycomb, a mixture of a first catalyst, which is Pt carried by alumina, and a second catalyst, which is Ru carried by alumina.

This carbon monoxide purifying catalyst body 1 is provided in a reaction chamber 2. A reformed gas supplied from a reformed gas supply part 125 through a reformed gas inlet 3 is fed to the reaction chamber 2 along with air supplied by an air pump 4. From the air pump 4 is supplied air so that the oxygen concentration becomes about 1 to 3 times the carbon monoxide concentration, for example, so that the oxygen concentration becomes 1 to 3% by volume when the carbon monoxide concentration is 1% by volume.

The reformed gas mixed with oxygen is fed to a reformed gas outlet 6 after the removal of carbon monoxide by the carbon monoxide purifying catalyst body 1. On the upstream side of the carbon monoxide purifying catalyst body 1 is provided a diffusion plate 5 so that the reformed gas flows uniformly. In order to maintain the reactor at a constant temperature, the outer periphery is covered with a heat insulating material 7 made of ceramic wool in necessary places.

Next, the principle of operation of the invention will be described.

As carbon monoxide purifying catalysts, conventionally a catalyst in which Pt, Pd, Ru, Rh, etc. are used as active components of the catalyst (the first catalyst in the invention) is used as a carbon monoxide selective oxidation catalyst and a catalyst in which Pd, Ru, Rh, Ni, etc. are used as active components of the catalyst (the second catalyst in the invention) is used as a carbon monoxide methanation catalyst.

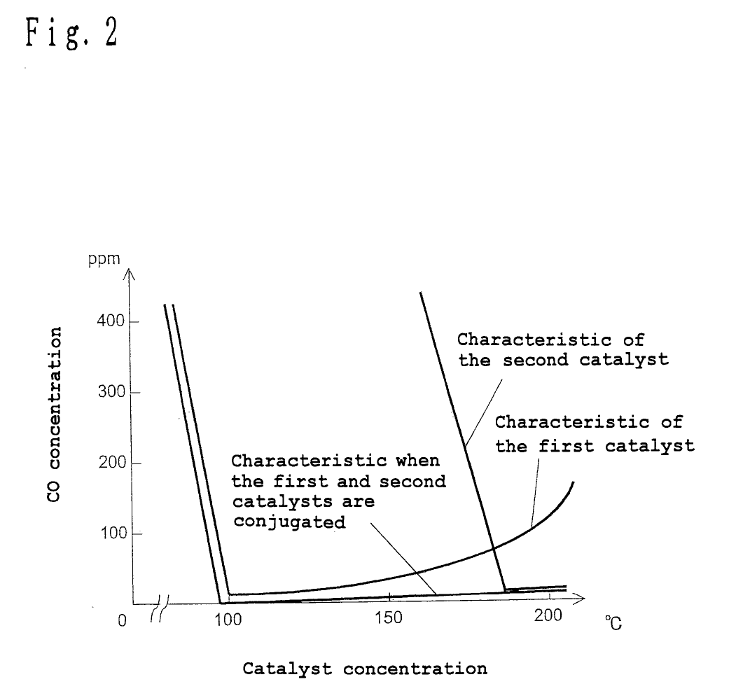

The relationship between the catalyst temperature and the carbon monoxide concentration in the reformed gas after passing through the carbon monoxide clarifying catalyst body is shown in FIG. 2 in a case where the first catalyst is singly used (a), a case where the second catalyst is singly used (b) and a case where the first catalyst and the second catalyst are mixed, which is the embodiment of the invention (c).

As the first catalyst body, a catalyst in which 1% by weight of Pt is carried by alumina in a distributed condition was coated on a carrier base material made of cordierite in honeycomb shape. And as the second catalyst body, a catalyst in which 1% by weight of Ru is carried by alumina in a distributed condition was coated on a carrier base material made of cordierite in honeycomb shape. All reaction conditions are the same with the exception that there is a difference in the carbon monoxide purifying catalyst body 1.

From the air pump 4 was supplied oxygen in amounts twice to six times the stoichiometric amount necessary for the oxidation reaction of the carbon monoxide contained in the reformed gas.

FIG. 2 shows that when the first catalyst is singly used, the carbon monoxide in the reformed gas is selectively oxidized and the carbon monoxide concentration is lowered to several parts per million, but the carbon monoxide concentration increases exponentially with increasing temperature due to the effect of the reverse shift reaction between carbon dioxide and hydrogen. This means that the temperature range in which the carbon monoxide concentration can be sufficiently lowered is limited to several ten degrees centigrade. However, because the catalyst temperature rises due to reaction heat, high-level control is required to maintain an optimum temperature.

Also, FIG. 2 shows that when the second catalyst is singly used, it is possible to lower the carbon monoxide concentration to several parts per million in a relatively high temperature region. This is because Ru promotes the methanation reaction of carbon monoxide. However, because the methanation reaction of carbon dioxide also proceeds exponentially and the hydrogen concentration is lowered as the temperature rises, the efficiency as a hydrogen generation apparatus decreases.

Therefore, the temperature range in which the methane concentration can be lowered to 1% through 2% by volume which has a small effect on the efficiency of the system is limited to several ten degrees centigrade. However, because the methanation reaction is also an exothermic reaction, high-level control is required to maintain an optimum temperature.

On the other hand, FIG. 2 shows that when the first and second catalysts are mixed, it is possible to remove carbon monoxide to low concentrations in a wide temperature range. Although the temperature range in which the first catalyst can remove carbon monoxide to several parts per million is about several ten degrees centigrade, carbon monoxide can be reduced in a temperature range of about 100 degrees if the carbon monoxide concentration is to be lowered to levels of several hundred parts per million. Furthermore, although the second catalyst virtually functions only in a narrow temperature range of several ten degrees centigrade in the case of high-concentration carbon monoxide of 0.5 to 1% by volume, the second catalyst can reduce carbon monoxide to not more than several parts per million in a temperature range of 100 degrees in the case of low-concentration carbon monoxide of several hundred parts per million or so.

Therefore, the carbon monoxide formed by the reverse shift reaction can be removed by the methanation reaction due to the combined effect of the first and second catalysts. For this reason, carbon monoxide can be removed to levels of several parts per million in a wide temperature range.

The temperature range in which carbon monoxide can be efficiently removed is not less than a temperature at which carbon monoxide can be removed by the first catalyst to several hundred parts per million and is less than a temperature at which the methanation reaction of carbon dioxide by the second catalyst begins to proceed such that this reaction has an effect on the efficiency of the system. This desirable temperature range, which depends on the active components, carried amount, etc. of a catalyst, is generally 60 to 350° C., preferably 80 to 250° C.

This embodiment is preferred when the carbon monoxide concentration in the reformed gas is 0.1 to 2% by volume. As the first and second catalysts, catalysts in which catalytic active components in amounts of 0.1 to 10% by weight are carried by a carrier are suitably used.

The catalytic active components used in the first catalyst are those which selectively show activity to the reaction given by 2CO+O₂→2CO₂ (chemical formula 1), i.e., those which show activity only to the oxidation reaction of carbon monoxide out of the hydrogen and carbon monoxide contained in the reformed gas or those which highly selectively shows activity to the oxidation reaction of carbon monoxide.

As such catalytic active components, noble metals such as Pt, Pd, Ru and Rh can be exemplified. In particular, it is preferred that as catalytic active components at least Pt or Ru be contained.

Furthermore, the catalytic active components used in the second catalyst are those which selectively show activity to the reaction given by CO+3H₂→CH₄+H₂O (chemical formula 2), i.e., out of the CO₂ and CO contained in the reformed gas, those which show activity only to the hydrogenation reaction of CO or those which highly selectively shows activity to the hydrogenation reaction of CO. As such catalytic active components, noble metals such as Ru, Rh, Pd and Ni can be enumerated. In particular, it is preferred that as catalytic active components at least Ru, Rh or Ni be contained.

There is no limitation on the carriers used in the first and second catalysts, and any carrier that can carry catalytically active components in a highly dispersed condition may be used. As such carriers, alumina, silica, silica alumina, magnesia, titania, zeolite, etc. can be exemplified. As the types of zeolite that can carry catalytic active components in a highly dispersed condition, A-type zeolite, X-type zeolite, Y-type zeolite, β-typezeolite, mordenite, ZSM-5, etc. can be exemplified. These carriers may be singly used or two or more carriers may be used in combination.

In this embodiment, each catalytic active component was caused to be carried by a powdery carrier beforehand, the first catalyst and second catalyst were composed of different particles, the first catalyst and second catalyst were physically mixed and coated on a cordierite honeycomb, which is a carrier base material. However, other forms of the first catalyst and second catalyst may be used if the first catalyst and second catalyst can display their respective functions of selective oxidation of carbon monoxide and hydrogenation reaction of carbon monoxide.

That is, the same effect can be obtained, as a method of making a composite catalyst, first by coating the first catalyst on a carrier base material and then by coating the second catalyst to make the catalysts in a composite form in layers. Furthermore, the first catalyst and second catalyst in pellet form may be prepared and then mixed.

Even when the average value of the compositions of the carbon monoxide purifying catalysts in a composite form is the same as in this embodiment, in a case where Pt and Ru are simultaneously carried by an alumina carrier, for example, the noble metals may sometimes be alloyed together. In this case, the activity in the methanation reaction of carbon monoxide is not very high although the activity in the selective oxidation of carbon monoxide is improved. This is because the characteristics of the respective catalytic active components of Pt and Ru become averaged by the alloying of Pt and Ru. Because an alloyed catalyst can be used as the first catalyst, higher performance can be obtained by mixing an Ru catalyst, etc. as the second catalyst.

The composite ratio of the catalytic active components of the first and second catalysts can be selected by those skilled in the art so that the carbon monoxide concentration after passing through the carbon monoxide purifying catalyst body becomes 0.01 to 100 ppm, preferably 0.01 to 20 ppm depending on the reaction conditions used. Usually, high performance is obtained with the ratio of the first catalyst in the range of 10 to 90% by weight.

There are catalysts, such as an Ru catalyst, which combine the performance of selective oxidation reaction and methanation reaction even in single use and have performance intermediate between the first and second catalysts. However, because optimum compositions for the selective oxidation reaction of carbon monoxide and the selective methanation reaction of carbon monoxide are different, high performance is obtained by making composite Ru catalysts of different compositions or preparation conditions as the first and second catalysts.

(Embodiment 2)

Next, an embodiment of an apparatus of hydrogen purification in which the carbon monoxide purifying catalyst body is divided into a plurality of stages and an oxidizing gas supply part to introduce an oxidizing gas into each of the above-described catalyst bodies is provided will be described especially about points in which Embodiment 2 is different from Embodiment 1.

When the volume of a carbon monoxide shifting catalyst body to cause carbon monoxide and steam to react with each other is reduced or the carbon monoxide shifting catalyst body is omitted in order to miniaturize a hydrogen generation system, there are cases where the carbon monoxide concentration becomes high and carbon monoxide cannot be sufficiently removed by a one-stage carbon monoxide purifying catalyst body. Furthermore, although an upper limit is set to the air volume introduced at a time in terms of the effect of reaction heat and of safety, there are cases where a hydrogen concentration exceeding this upper limit may sometimes be required when the carbon monoxide concentration is high.

In this embodiment, the carbon monoxide purifying catalyst body is divided into a plurality of stages, preferably two or three stages, and on the upstream side of each catalyst body is provided an oxidizing gas supply part to supply an oxidizing gas. Therefore, air can be supplied twice or more times and carbon monoxide can be efficiently removed even when the carbon monoxide concentration is relatively high. This embodiment is preferable when the carbon monoxide concentration in the reformed gas is 1 to 3% by volume.

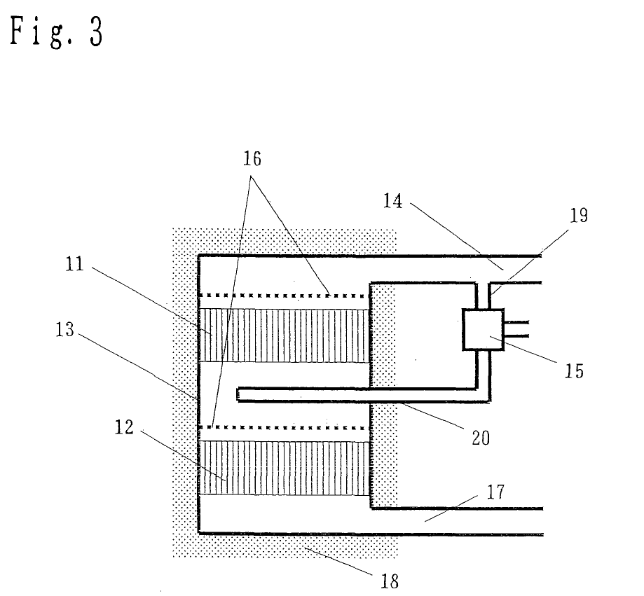

FIG. 3 is a schematic diagram showing the configuration of an apparatus of hydrogen purification related to Embodiment 2 of the invention. In FIG. 3, a carbon monoxide purifying catalyst body is divided into the two stages of a first purifying catalyst 11 and a second purifying catalyst 12, and a second air supply part 20 is provided between the two purifying catalysts.

It is preferred that air be supplied from a first air supply part 19 so that the oxygen concentration becomes 1 to 2% by volume of the whole and that air be supplied from the second air supply part 20 so that the oxygen concentration becomes 0.5 to 1.5% by volume of the whole

Because at a high carbon monoxide concentration oxygen is insufficient only with the air supplied from the first air supply part 19, the oxidation reaction does not proceed sufficiently when the reformed gas passes through the first catalyst 11. However, because air is again supplied from the second air supply part 20, the oxidation of carbon monoxide proceeds further during the passing through the second purifying catalyst 12 and the carbon monoxide concentration is further lowered to levels of several parts per million.

An apparatus of hydrogen purification of the invention will be described below more concretely on the basis of examples.

### EXAMPLE 1

Alumina which carried Pt as the first catalyst (the carried amount of Pt is 1% by weight) and alumina which carried Ru as the second catalyst (the carried amount of Ru is 1% by weight) were mixed at a ratio of 50% by weight and coated on a cordierite honeycomb 100 mm in diameter and 50 mm in length.

A carbon monoxide purifying catalyst body 1 thus obtained was provided in the reaction chamber 2 of an apparatus of hydrogen purification as shown in FIG. 1 and a reformed gas consisting of 1% carbon monoxide by weight, 15% carbon dioxide by weight, 15% steam by weight and the balance of hydrogen was introduced from a reformed gas inlet at a flow rate of 10 liters per minute.

From the air supply part 4 was supplied air so that the oxygen concentration became 2% by volume of the whole. A reaction was caused to occur by cooling the reformed gas before the reformed gas inlet 3 and changing the reformed gas temperature between 80° C. and 250° C. The composition of the gas discharged from the reformed gas outlet 6 was measured by gas chromatography after the removal of moisture and the carbon monoxide concentration and methane concentration were calculated. The result is shown in Table 1.

TABLE 1

| | Reformed gas temperature | | | | |
|---|---|---|---|---|---|
| | 80° C. | 100° C. | 150° C. | 200° C. | 250° C. |
| CO concentration | 50 | 0.1 | 0.3 | 1.5 | 3 |
| (ppm) | | | | | |
| Methane | 0 | 0 | 0.04 | 0.3 | 1 |
| concentration | | | | | |

### EXAMPLE 2

As shown in FIG. 3, the carbon monoxide purifying catalyst body was divided into two parts of a first purifying catalyst 11 and a second purifying catalyst 12, and a second air supply part 20 was arranged between the purifying catalysts. And a reformed gas containing 2% by volume of carbon monoxide, 14% by volume of carbon dioxide, 15% by volume of steam and the balance of hydrogen was introduced from a reformed gas inlet 14 at a flow rate of 10 liters per minute. From the first air supply part 19 and the second air supply part 20 was supplied air so that the oxygen concentration each became 2% by volume of the whole.

A reaction was caused to occur by cooling the reformed gas before the reformed gas inlet 14 and changing the reformed gas temperature between 80° C. and 250° C. The composition of the gas discharged from the reformed gas outlet 17 was measured by gas chromatography after the removal of moisture and the carbon monoxide concentration and methane concentration were calculated. The result is shown in Table 2.

TABLE 2

| | Reformed gas temperature | | | | |
|---|---|---|---|---|---|
| | 80° C. | 100° C. | 150° C. | 200° C. | 250° C. |
| CO concentration | 300 | 0.1 | 0.03 | 1.5 | 3 |
| (ppm) | | | | | |
| Methane | 0 | 0 | 0.05 | 0.2 | 0.5 |
| concentration | | | | | |

Incidentally, by providing a heat radiation part or a cooling part between the catalyst bodies thereby to remove heat generated on the upstream side, it is possible to optimally control the temperature of the catalyst body on the downstream side.

### EXAMPLE 3

The same operation as in Example 1 was carried out with the exception that the second catalyst was replaced with a catalyst which used Rh in place of Ru. The result is shown in Table 3.

TABLE 3

| | Reformed gas temperature | | | | |
|---|---|---|---|---|---|
| | 80° C. | 100° C. | 150° C. | 200° C. | 250° C. |
| CO concentration | 60 | 0.1 | 0.25 | 1.4 | 3 |
| (ppm) | | | | | |
| Methane | 0 | 0 | 0.05 | 0.25 | 0.4 |
| concentration | | | | | |

### EXAMPLE 4

The same operation as in Example 1 was carried out with the exception that the second catalyst was replaced with a catalyst which used Ni in place of Ru. The result is shown in Table 4.

TABLE 4

| | Reformed gas temperature | | | | |
|---|---|---|---|---|---|
| | 80° C. | 100° C. | 150° C. | 200° C. | 250° C. |
| CO concentration | 80 | 0.15 | 0.5 | 5 | 15 |
| (ppm) | | | | | |
| Methane | 0 | 0 | 0.1 | 0.15 | 0.3 |
| concentration | | | | | |

### COMPARATIVE EXAMPLE 1

The same operation as in Example 1 was carried out with the exception that the second catalyst was removed. The result is shown in Table 5.

TABLE 5

| | Reformed gas temperature | | | | |
|---|---|---|---|---|---|
| | 80° C. | 100° C. | 150° C. | 200° C. | 250° C. |
| CO concentration | 300 | 5 | 50 | 200 | 500 |
| (ppm) | | | | | |
| Methane | 0 | 0 | 0 | 0 | 0.1 |
| concentration | | | | | |

### COMPARATIVE EXAMPLE 2

The same operation as in Example 1 was carried out with the exception that the first catalyst was removed. The result is shown in Table 6.

TABLE 6

| | Reformed gas temperature | | | | |
|---|---|---|---|---|---|
| | 80° C. | 100° C. | 150° C. | 200° C. | 250° C. |
| CO concentration | 9900 | 9500 | 9000 | 10 | 3 |
| (ppm) | | | | | |
| Methane | 0 | 0 | 0.06 | 0.2 | 1 |
| concentration | | | | | |

### COMPARATIVE EXAMPLE 3

Pt and Ru were caused to be carried by alumina each at a ratio of 0.5% by weight and were coated on a cordierite honeycomb 100 mm in diameter and 50 mm in length thereby to prepare a carbon monoxide purifying catalyst body. The result of the same operation as in Example 1, which was carried out for this carbon monoxide purifying catalyst body, is shown in Table 7.

TABLE 7

| | Reformed gas temperature | | | | |
|---|---|---|---|---|---|
| | 80° C. | 100° C. | 150° C. | 200° C. | 250° C. |
| CO concentration | 250 | 4 | 45 | 150 | 450 |
| (ppm) | | | | | |
| Methane | 0 | 0 | 0 | 0 | 0.2 |
| concentration | | | | | |

As is apparent from the above descriptions, according to the invention, a carbon monoxide purifying catalyst body can be caused to function in a wide temperature range and it is possible to provide an apparatus of hydrogen purification which is capable of removing carbon monoxide in a stable manner.

Furthermore, other embodiments of the invention will be described by using drawings.

### EMBODIMENT 3

FIG. 1 is a diagram showing the configuration of an apparatus of hydrogen purification related to Embodiment 3 of the invention. In the figure, a hydrogen gas supply part, i.e., a reformed gas supply part is constituted by a raw material supply part 23 which supplies a raw material to a reforming catalyst 22 housed in a reformer 21, a water supply part 24 which supplies water to the reforming catalyst 22, a reformer heating part 25 which heats there forming catalyst 22, a shift converter 26, and a shift catalyst 27 housed in the shift converter. The configuration of the reformed gas supply part is a usual configuration.

The numeral 8 denotes a purifying part in which a purifying catalyst body 29 is housed. The numeral 10 denotes a cooling fan to cool hydrogen gas to be supplied to a purifying part 28, and the numeral 11 denotes an air pump which feeds air as an oxidizing gas into the interior of the purifying part 28. The numeral 12 denotes a temperature detection part provided downstream of the purifying part 28, and on the basis of temperatures detected there, the operation of a cooling fan 210 and an air pump 211 is controlled by a control part 213 and the temperature is maintained in a constant temperature range so that the purifying catalyst body 29 can sufficiently reduce carbon monoxide. Detailed descriptions mainly of the purifying part 28 will be given below as required.

The operation of the apparatus of the above-described configuration will be described on the basis of an example in which methane gas was used as a raw material. At the start of the apparatus, the heating of the reformer 21 was started by use of the reformer heating part 25 and heat was transmitted to the reforming catalyst 22. Subsequently, methane gas as a hydrocarbon component, which was a raw material, was supplied from the raw material supply part 23 to the reforming catalyst 22, and water was supplied from the water supply part 24 to the reforming catalyst 22 in an amount of 4 moles for 1 mole of methane gas.

Incidentally, in this embodiment, the volume of methane gas supplied to the reforming catalyst 22 was 6 l/minute and the steam reforming reaction was caused to proceed by controlling the amount of heat by the reformer heating part 25 so that the temperature of the reforming catalyst 22 became about 750° C. The hydrogen gas after the reaction in the reformer 1 was supplied to the shift converter 26. Because the hydrogen gas supplied to the shift converter 26 contains steam, carbon dioxide and about 10% carbon monoxide, the carbon monoxide concentration was lowered to several thousand parts per million through 1% or so by the shift reaction of carbon monoxide with steam by passing through the shift catalyst 27. To further lower the carbon monoxide concentration, the hydrogen gas coming from the shift converter 26 was supplied to the purifying part 28.

On the purifying catalyst body 29 housed in the purifying part 28 proceeds the oxidation reaction of the carbon monoxide in the hydrogen gas with the oxygen in the air supplied by the air pump 211.

As the purifying catalyst 29, zeolite was caused to carry Cu by ion exchange with a Cu salt solution and then further carry Pt by the impregnation of a Pt salt solution. This material was sintered at 500° C. in the air and coated on a cordierite honeycomb for use as the purifying catalyst (hereinafter referred to as Pt—Cu/zeolite).

By causing zeolite to carry Cu and Pt by ion exchange, Cu and Pt are carried in a highly dispersed condition and active points for the reaction between carbon monoxide and oxygen increase. Therefore, carbon monoxide can be positively reduced by the oxidation reaction between carbon monoxide and oxygen. As a result, even at low temperatures near the dew point (about 70° C.) carbon monoxide can be reduced to not more than 10 ppm.

Furthermore, by causing Cu and Pt to coexist in activity points, Cu attracts electrons present on Pt and this is effective in suppressing the adsorption of carbon monoxide. Therefore, it is possible to suppress the reverse shift reaction which occurred as a side reaction in conventional Pt-based purifying catalysts. As a result, even at high temperatures of not less than 200° C., it is possible to reduce carbon monoxide to not more than 10 ppm.

Incidentally, in the first transition metals of the first long period, such as Cu, when carried by zeolite by ion exchange, their oxidation condition is apt to change due to the nature of electrons on the 3d orbit which is peculiar to the first transition metals of the first long period and they are peculiar substances that are apt to affect the electron condition of coexistent noble metals such as Pt. Therefore, the same effect is obtained also from Sc, Ti, V, Cr, Mn, Fe, Co, Ni and Zn, which are the first transition metals of the first long period other than Cu.

Incidentally, although the same effect is obtained also from other noble metals such as Pd, Ru and Rh used in place of Pt, the characteristic of Pt is the best.

Incidentally, when the first transition metals of the first long period and noble metals are carried by zeolite by ion exchange, the first transition metals of the first long period and noble metals are carried by Al atoms in an anion state. For this reason, because the force of mutual reaction between the first transition metals of the first long period and noble metals becomes weak when the Si/Al ratio of zeolite is too high, it is preferred that a zeolite with an Si/Al ratio of not more than 100 be used. Furthermore, in consideration of the particle sizes of the first transition metals of the first long period and noble metals, a zeolite with an Si/Al ratio of 2 to 10 or so is preferable. In particular, Y-type zeolite or mordenite is preferable.

Incidentally, by causing zeolite to carry first a transition metal of the first long period by ion exchange and then a noble metal, the transition metal of the first long period and the noble metal are carried by zeolite in a good coexistent condition and hence a better effect is obtained than in a case where the transition metal of the first long period is carried after the noble metal.

As a result of the proceeding of the oxidation reaction with the oxygen in the air on the purifying catalyst body 29, it is possible to lower the carbon monoxide concentration at the outlet of the purifying part to not more than 10 ppm in a stable manner in a wide temperature range from a low temperature region of about 70° C. to a high-temperature region of about 250° C.

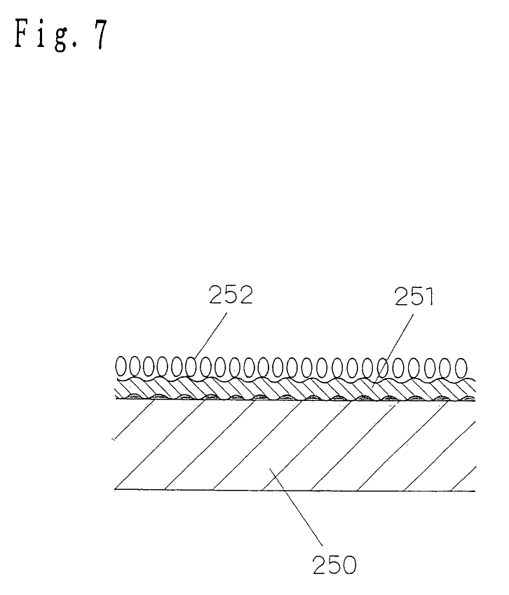

An example of the relationship between a carrier 50 and a transition metal 51 and a noble metal 52 is shown in FIG. 7. However, what is important is that a carrier, a transition metal and a noble metal coexist, and the purifying catalyst body is not limited to the configuration shown in FIG. 7.

(Embodiment 4)

By combining the purifying catalyst body in the invention with conventionally used catalysts prepared by metal oxides and noble metals, it is possible to further positively lower the carbon monoxide concentration at the outlet of the purifying part.

FIG. 2 is a diagram showing the configuration of an apparatus of hydrogen purification in the fourth embodiment of the invention, and this embodiment will be described mainly about points in which this embodiment is different from FIG. 1 in Embodiment 3.

The numeral 21 denotes a purifying part. A second purifying catalyst body 22 is provided on the upstream side of the flow of direction of hydrogen gas, and the purifying catalyst body described in Embodiment 3 is provided on the downstream side as a first purifying catalyst body 23. The temperature within the purifying part 221 is controlled, as with Embodiment 3, by a control part 213 by means of a cooling fan 210 and an air pump 211 on the basis of temperatures detected by a temperature detection part 212.

As the second purifying catalyst body 22, powder alumina carrying Pt was coated on a cordierite honeycomb (hereinafter referred to as Pt/alumina).

The second purifying catalyst body 22 prepared as described above can lower the carbon monoxide concentration at the outlet of the purifying part 2 in a temperature range from about 100° C. to about 200° C. even when the carbon monoxide concentration at the outlet of the shift converter 26 is high and exceeds 1%. This is because carbon monoxide is reduced by the methanation reaction in addition to the oxidation reaction. Because the methanation reaction is a reaction between carbon monoxide and hydrogen, the amount of hydrogen formed at the outlet of the purifying part 2 decreases, resulting in an undesirable decrease in reforming efficiency. However, even when the carbon monoxide concentration at the outlet of the shift converter 26 exceeds 1%, it is possible to reduce carbon monoxide to not more than 10 ppm at the outlet of the purifying part 2.

In the case of single use of the second purifying catalyst body 22, when the supply of methane gas to the reforming catalyst 22 is started, i.e., at the start of the apparatus, it was impossible to lower the carbon monoxide concentration unless the temperature of the purifying catalyst body is raised to a temperature of not less than 100° C. As a result, it took a long time before the carbon monoxide concentration at the outlet of the purifying part 2 began to be lowered to not more than 10 ppm. Furthermore, when the temperature of the purifying catalyst body exceeded 200° C., the reverse shift reaction between carbon dioxide and steam proceeded and sometimes carbon dioxide could not be reduced.

In this embodiment, by providing the Pt/alumina catalyst on the upstream side within the purifying part 221 and the Pt—Cu/zeolite catalyst on the downstream side, the carbon monoxide concentration can be lowered by means of the downstream Pt—Cu/zeolite catalyst when the temperature in the purifying part 221 is low and the carbon monoxide concentration can be lowered by means of the upstream Pt/alumina catalyst when the temperature in the purifying part is 100° C. to 200° C. or so.

Furthermore, even when all the oxygen in the air is consumed by the upstream Pt/alumina catalyst, the reverse shift reaction does not proceed in the downstream Pt—Cu/zeolite catalyst. Therefore, it is possible to lower the carbon monoxide concentration at the outlet of the purifying part to not more than 10 ppm.

In this embodiment, the Pt/alumina catalyst was used as the second purifying catalyst body 22. However, a similar effect can also be obtained by using other metal oxides and mixed oxides of Si, Zr, Ti, Ce, etc. plus other noble metals such as Ru, Pd and Rh singly or in combination and also by causing alloyed noble metals such as Pt—Ru to be carried.

(Embodiment 5)

Also by dividing the purifying part into two stages and providing a purifying catalyst body in each stage and by controlling the temperature of each purifying catalyst body, it is possible to positively lower the carbon monoxide concentration at the outlet of the purifying part to not more than 10 ppm.

FIG. 3 is a diagram showing the configuration of an apparatus of hydrogen purification in Embodiment 5 of the invention, and this embodiment will be described mainly about points in which this embodiment is different from FIG. 1 in Embodiment 3.

The numeral 31 denotes a second purifying part, and a second purifying catalyst body 32, a second air pump 233 and a second temperature detection part 234 are provided The Pt/alumina catalyst was used as the second purifying catalyst body 32. The temperature within a second purifying part 231 is controlled by a control part 241 by means of the second air pump 233 and a second cooling fan 235 on the basis of temperatures detected by the second temperature detection part 234.

The numeral 36 denotes a first purifying part 36, and a first purifying catalyst body 37, a first air pump and a first temperature detection part 239 are provided. The Pt—Cu/zeolite catalyst was used as the first purifying catalyst body 37. The temperature within the first purifying part 236 is controlled by a control part 241 by means of a first air pump 238 and a first cooling fan 240 on the basis of temperatures detected by the first temperature detection part 239.

When the purifying part is divided into two stages as described above, the catalyst temperature can be controlled within a temperature range in which each catalyst type can reduce carbon monoxide to a maximum degree. That is, because control suited to catalyst types can be carried out individually, it is possible to further positively reduce the carbon monoxide concentration at the outlet of the purifying part to not more than 10 ppm.

Incidentally, in this embodiment the second and first temperature detection parts detect the temperature of hydrogen gas. However, a similar effect can also be obtained by the direct detection of the second and first purifying catalyst bodies by means of the second and first temperature detection parts.

Incidentally, it is needless to say that the carbon monoxide concentration at the outlet of the purifying part can also be lowered in a stable manner by performing control by dividing the purifying parts into three or more stages and providing a purifying catalyst body, an air pump and a cooling fan in each purifying part.

(Embodiment 6)

Furthermore, the carbon monoxide concentration at the outlet of the purifying part can be lowered to not more than 10 ppn by controlling the supply of air as an oxidizing gas according to catalyst types, and an improvement in reforming efficiency can be realized by suppressing hydrogen consumption due to the oxidation of hydrogen.

The configuration of an apparatus of hydrogen purification in Embodiment 6 is shown in FIG. 3. Because this configuration is the same as that of Embodiment 5, detailed descriptions are omitted.

The point in which Embodiment 6 differs from Embodiment 5 resides in the fact that a reference temperature is set in a second temperature detection part 234. In this embodiment, the reference temperature is set at 100° C. When a detected temperature is lower than the reference temperature, air is supplied to a first purifying catalyst 37 alone by operating a first air pump 238 alone without operating a second air pump 233. When a detected temperature is not less than the reference temperature, a first air pump 38 is stopped and air is supplied to a second purifying catalyst 32 by operating the second air pump 233 alone.

Because at the start of the apparatus a temperature detected by the second temperature detection part 234 is not more than 100° C., the second air pump 233 is not operated and only the first air pump 238 is operated. Because a first purifying catalyst body 237 can reduce carbon monoxide even in a low-temperature region of about 70° C., a temperature rise of the purifying catalyst body does not take time and the time till carbon monoxide can be reduced to not more than 10 ppm becomes short.

The reason why the second air pump 233 is not operated is described below. Even if air is supplied when a temperature detected by the second temperature detection temperature is lower than 100° C., the second purifying catalyst body 32 does not reduce carbon monoxide. However, because hydrogen reacts with the oxygen in the air, hydrogen is consumed, resulting in a decrease in reforming efficiency. For this reason, air is not supplied until a temperature at which the second purifying catalyst body 32 can reduce carbon monoxide is reached.

Furthermore, when a temperature detected by the second temperature detection part 234 becomes not less than 100° C., a second purifying catalyst body 232 comes to be able to reduce carbon monoxide and, therefore, the second air pump 233 is operated to supply air. However, after the carbon monoxide concentration is lowered to not more than 10 ppm by a second purifying part 231, the oxygen in the air reacts with hydrogen in a second purifying part 236, resulting in a decrease in reforming efficiency. Therefore, the first air pump 238 is stopped and hydrogen is prevented from being consumed by the oxygen.

As described above, by setting a reference temperature and stopping the operation of the oxidizing gas supply part, the consumption of hydrogen can be prevented and an improvement in reforming efficiency can be realized.

Incidentally, in this embodiment the second and first temperature detection parts detect the temperature of hydrogen gas. However, a similar effect can also be obtained by the direct detection of the second and first purifying catalyst bodies by means of the second and first temperature detection parts.

Incidentally, not only by completely stopping the second and first air pumps 33, 38, but also by increasing or decreasing the volume of supplied air, similarly it is possible to lower the carbon monoxide concentration to not more than 10 ppm in a stable manner and the hydrogen consumption by oxidation can be suppressed.

Incidentally, an effect is obtained by performing a similar operation which involves using the first temperature detection part 239 and setting a reference temperature.

Incidentally, a reference temperature can be set variously depending on the configuration of the apparatus and catalyst types.

### EXAMPLE 5

After a zeolite which has an Si/Al ratio of 5 was caused to carry one of the first transition metals of the first long period (the element names are shown in Table 8) by ion exchange with solutions of transition metal salts of the first long period, the zeolite was caused to further carry one of the noble metals by the impregnation in solutions of noble metal slats (the element names are shown in Table 8). This material was sintered at 500° C. in the air and noble-metal-transition metal of the first long period/zeolite catalysts were prepared. The catalysts thus prepared were coated on a cordierite honeycomb and such catalysts were provided as the purifying catalyst body 29 within the apparatus of hydrogen purification shown in FIG. 1.

Methane gas was supplied at 6 l/minute from the raw material supply part 23 to the reforming catalyst body 22 and water in liquid form was also supplied at 19 g/minute from the water supply part 24, and the steam reforming reaction was caused to proceed by controlling the amount of heat by the reformer heating part 25 so that the temperature of the reforming catalyst 22 became 750° C. As a result, the methane conversion rate became 100% and the composition of the gas supplied to the shift converter 26 consisted of 8% carbon monoxide, 8% carbon dioxide, 20% steam and the balance of hydrogen. The gas of this composition was supplied to the shift converter 26 and as a result of the shift reaction in the shifting catalyst body 27, the composition of the gas supplied to the purifying part 28 consisted of 0.5% carbon monoxide, 15% carbon dioxide, 12% steam and the balance of hydrogen. The gas of this composition was caused to react with the oxygen in the air, which was caused to flow at 3 l/minute by means of the air pump 211, and the composition of the gas discharged to the outlet 214 of the purifying part was measured by gas chromatography.

Measurements were made by changing the temperature of the purifying catalyst body 9. The temperature ranges in which the carbon dioxide concentration became not more than 10 ppm are shown in Table 8.

| | | Temperature |
|---|---|---|
| Sample No. | Catalyst type | range |
| 1 | Pt—Cu/zeolite | 70° C.˜220° C. |
| 2 | Pt—Sc/zeolite | 70° C.˜180° C. |
| 3 | Pt—Ti/zeolite | 70° C.˜190° C. |
| 4 | Pt—V/zeolite | 70° C.˜190° C. |
| 5 | Pt—Cr/zeolite | 70° C.˜190° C. |
| 6 | Pt—Mn/zeolite | 70° C.˜210 C. |
| 7 | Pt—Fe/zeolite | 70° C.˜200° C. |
| 8 | Pt—Co/zeolite | 70° C.˜200° C. |
| 9 | Pt—Ni/zeolite | 70° C.˜200° C. |
| 10 | Pt—Zn/zeolite | 70° C.˜210° C. |
| 11 | Ru—Cu/zeolite | 80° C.˜200° C. |
| 12 | Pd—Cu/zeolite | 90° C.˜220° C. |
| 13 | Rh—Cu zeolite | 90° C.˜210° C. |
| 14 | Pt/zeolite | 70° C.˜150° C. |
| | (comparative example) | |

The experiment result shown in Table 8 supports the following fact which was described above. By causing a noble metal to be carried by zeolite, carbon monoxide can be reduced even at low temperatures. In particular, when Pt was used as a noble metal, carbon monoxide could be reduced to not more than 10 ppm even at a low temperature of 70° C., Furthermore, because a transition metal of the first long period was caused to coexist with a noble metal, carbon monoxide could be reduced even at high temperatures. In particular, when Cu was used as a transition metal of the first long period, carbon monoxide could be reduced to not more than 10 ppm even at 220° C.

As a comparative example, measurements were made by the above-described method also for a catalyst in which zeolite carries only Pt without carrying a transition metal of the first long period (Sample No. 14 in Table 8). As a result, the temperature range in which the carbon monoxide concentration became not more than 10 ppm was only from 70° C. to 150° C. and carbon dioxide could not be reduced in a high temperature region.

### EXAMPLE 6

After zeolites with different Si/Al ratios (the Si/Al ratios are shown in Table 9) were caused to carry Cu by ion exchange with a copper nitrate solution, the zeolites were caused to further carry Pt by the impregnation in a Pt salt solution. These materials were sintered at 500° C. in the air and Pt—Cu/zeolite catalysts were prepared. The catalysts thus prepared were coated on a cordierite honeycomb. This catalyst was provided as the purifying catalyst body 9 within an apparatus of hydrogen purification shown in FIG. 1. The apparatus was operated in the same manner as in Example 5, and the composition of the gas discharged to the outlet 214 of the purifying part was measured by gas chromatography as in Example 5.

Measurements were made by changing the temperature of the purifying catalyst body 9. The temperature ranges in which the carbon dioxide concentration became not more than 10 ppm are shown in Table 9.

TABLE 9

| Sample No. | Si/Al ratio | Temperature range |
|---|---|---|
| 1 | 1 | 100° C.˜200° C. |
| 2 | 2 | 90° C.˜220° C. |
| 3 | 5 | 70° C.˜220° C. |
| 4 | 6 | 80° C.˜210° C. |
| 5 | 200 | 100° C.˜170° C. |
| 6 | 1000 | 110° C.˜190° C. |

The experiment result shown in Table 9 supports the following fact which was described above. With zeolites having an Si/Al ratio exceeding 100, it was impossible to reduce carbon monoxide to not more than 10 ppm in a high temperature region. With zeolites of small Si/Al ratio, it was impossible to reduce carbon monoxide to not more than 10 ppm in a low temperature region. The zeolite with an Si/Al ratio of 5 had the widest temperature region in which carbon monoxide is reduced to not more than 10 ppm, which was 70° C. to 220° C.

### EXAMPLE 7

A Pt/alumina catalyst was prepared by the impregnation of alumina powder in a Pt salt solution. This Pt/alumina catalyst was coated on a cordierite honeycomb and provided as the second purifying catalyst body 22 on the upstream side of the purifying part 221 within the apparatus of hydrogen purification shown in FIG. 2. Furthermore, a Pt—Cu/zeolite prepared as shown in Example 6 by use of a zeolite having an Si/Al ratio of 5 was provided as the first purifying catalyst 23 on the downstream side of the purifying part 221. The apparatus was operated in the same manner as in Example 5 and the composition of the gas discharged to the outlet 214 of the purifying part was measured by gas chromatography as in Example 5. When the temperature detected by the temperature detection part 212 was in the range from 70° C. to 230° C., carbon monoxide concentration could be stably lowered to not more than 10 ppm. Furthermore, the time from the start of supply of methane gas to the reforming catalyst 22 until carbon monoxide at the outlet of the purifying part 214 begins to be reduced to not more than 10 ppm, i.e., the startup time could be shortened from about the conventional 30 minutes to 15 minutes.

When a zeolite with an Si/Al ratio of 1 was used as the first purifying catalyst body, the temperature range in which the carbon monoxide concentration could be lowered to not more than 10 ppm was from 90° C. to 220° C. Furthermore, when Fe was used in place of Cu, the temperature range in which the carbon monoxide concentration could be lowered to not more than 10 ppm was from 70° C. to 210° C.

### EXAMPLE 8

As in Example 7, Pt/alumina and Pt—Cu/zeolite were prepared. The Pt/alumina was provided as the second purifying catalyst body 32 in the purifying part 31 within the apparatus of hydrogen purification shown in FIG. 3 and the Pt—Cu/zeolite was provided as the first purifying catalyst body 34 in the purifying part 36. The apparatus was operated in the same manner as in Example 5, and the composition of the gas discharged to the outlet 42 of the clarifying part was measured by gas chromatography as in Example 5. When the temperature detected by the temperature detection part 34 was in the range from 70° C. to 250° C., carbon monoxide concentration could be stably lowered to not more than 10 ppm. Furthermore, the startup time could be shortened to 15 minutes.

Incidentally, when a catalyst prepared from a zeolite with an Si/Al ratio of 1 was used in place of a zeolite with an Si/Al ratio of 5, the temperature range in which the carbon monoxide concentration could be lowered to not more than 10 ppm was from 90° C. to 230° C. Furthermore, when a catalyst prepared from Fe in place of Cu was used, the temperature range in which the carbon monoxide concentration could be lowered to not more than 10 ppm was from 70° C. to 220° C.

### EXAMPLE 9

As in Example 8, Pt/alumina was provided as the second purifying catalyst body 32 in the apparatus of hydrogen purification shown in FIG. 3 and Pt—Cu/zeolite was provided as the first purifying catalyst body 34.

The same operation of the apparatus was carried out as in Example 5. However, because a temperature detected by the temperature detection part was lower than 100° C. at the start of the apparatus, the second air pump 233 was not operated and only the first air pump 238 was operated to supply air at 3 l/minute to the interior of the purifying part 36. At this time, the oxidation reaction proceeded in a low temperature region only in the first purifying catalyst body 37, with the result that the carbon monoxide concentration at the outlet 42 of the purifying part could be lowered to not more than 10 ppm in 15 minutes after the start of supply of methane gas to the reforming catalyst 22.

After that, when the heat of the reformer was transmitted to the interior of the purifying part 31 and a temperature detected by the temperature detection part 34 became not less than 100° C., the second air pump 233 started to operate and supplied air at 3 l/minute to the interior of the clarifying part 31 and the first air pump 238 stopped operating. Therefore, the hydrogen consumption by oxidation at this time could be reduced by 1 l/minute in comparison with a case where the first air pump 238 continues operating.

Furthermore, when the methane gas volume and water volume supplied to the reforming catalyst 22 were reduced to half each in order to reduce the volume of hydrogen taken out from the outlet 42 of the purifying part as an operation during load variations, the temperature in the second and first purifying parts 31, 33 dropped and temperatures detected by the temperature detection part 34 also dropped gradually. When a temperature detected by the temperature detection part 34 became lower than 100° C., the second air pump 233 was stopped and the first air pump 238 was operated in the same manner as at the start of the apparatus. As a result, the carbon monoxide concentration at the outlet 42 of the purifying part 42 could be lowered to not more than 10 ppm in a stable manner even before and after load variations.

Incidentally, the noble metal in the above-described catalyst may be a noble metal oxide. Alternatively, both may coexist in a mixed manner.

Furthermore, the transition metal in the above-described catalyst may be a transition metal oxide. Alternatively, both may coexist in a mixed manner.

### INDUSTRIAL APPLICABILITY

As is apparent from the above descriptions, according to the present invention, it is possible to provide an apparatus of hydrogen purification in which a carbon monoxide catalyst body can function in a wide temperature region and carbon monoxide can be reduced in a stable manner.

Also, according to the invention, carbon monoxide can be reduced even at low temperatures, and even at high temperatures by suppressing the reverse shift reaction, so that it is possible to widen the temperature range in which carbon monoxide can be reduced to not more than 10 ppm.

Also according to the invention, it is possible to shorten the time till the point at which carbon monoxide begins to be reduced to not more than 10 ppm.

Furthermore, according to the invention, carbon monoxide can be reduced to not more than 10 ppm in a stable manner even during load variations.

Moreover, according to the invention, hydrogen consumption by oxidation can be suppressed. As a result, an apparatus of hydrogen purification with improved reforming efficiency can be supplied.

1. An apparatus of hydrogen purification comprising: a reformed gas supply part which supplies a reformed gas containing hydrogen and carbon monoxide, an oxidizing gas supply part to mix the reformed gas supplied from said reformed gas supply part with an oxidizing gas, and with oxygen passes, wherein said catalyst body being a substance in which at least two kinds of catalysts having different composition are mixed or integrated.

2. The apparatus of hydrogen purification according to claim 1, wherein said catalyst body is integrated by coating, in layers, a surface of a base material as a catalyst carrier with at least two kinds of catalysts having different compositions.

3. The apparatus of hydrogen purification according to claim 1 or 2, wherein said base material as a catalyst carrier is a heat-resisting base material in a honeycomb or pellet shape.

4. The apparatus of hydrogen purification according to any one of claims 1 to 3, wherein said catalyst body, a first catalyst containing at least one kind selected from the group consisting of Pt, Pd, Ru and Rh and a second catalyst containing at least one kind selected from the group consisting of Pd, Ru, Rh and Ni are mixed or integrated.

5. The apparatus of hydrogen purification according to any one of claims 1 to 4, wherein said catalyst body is divided into a plurality of stages and at least between the catalyst bodies is provided a heat radiation part or a cooling part.

6. The apparatus of hydrogen purification according to claim 1, wherein
said two kinds or more catalysts are each constituted by one kind or more transition metals and/or transition metal oxides, and at least one kind of noble metals selected from the group consisting of Pt, Ru, Pd and Rh and/or oxides of the noble metals, and
said two kinds or more catalysts, along with a carrier of oxide containing at least either Al or Si, each comprise a first purifying catalyst body.

7. The apparatus of hydrogen purification according to claim 6, wherein that said transition metals are first transition metals, Sc, Ti, V, Cr, Mn, Fe, Co, Ni, Cu and Zn.

8. The apparatus of hydrogen purification according to claim 6 or 7, wherein said oxide is zeolite.

9. The apparatus of hydrogen purification according to claim 6 or 7, wherein said oxide is a cation exchanger.

10. The apparatus of hydrogen purification according to any one of claims 6 to 9, wherein said first purifying catalyst body is such that said transition metals are carried by said oxide with ion exchange and thereafter at least one kind of noble metals selected from the group consisting of Pt, Ru, Pd and Rh is carried.

11. The apparatus of hydrogen purification according to any one of claims 6 to 11, wherein the Si/Al ratio of said zeolite is 1 to 100.

12. The apparatus of hydrogen purification according to any one of claims 6 to 11, wherein said first purifying catalyst body is such that Cu is carried by Y-type zeolite with ion exchange and thereafter Pt is carried.

13. The apparatus of hydrogen purification according to any one of claims 6 to 12, further comprising a second purifying catalyst body prepared by a metal oxide and a noble metal on the upstream side of said purifying part.

14. The apparatus of hydrogen purification according to claim 8, wherein said purifying part is divided into two stages, an upstream second purifying part comprising said second purifying catalyst body and a second oxidizing gas supply part which feeds an oxidizing gas to said second purifying catalyst body, and a downstream first purifying part comprising said first purifying catalyst body and a first oxidizing gas supply part which feeds an oxidizing gas to said first purifying catalyst body.

15. The apparatus of hydrogen purification according to claim 9, wherein a temperature detection part is provided in said second purifying part and/or said first purifying part to detect the temperature of said second purifying catalyst body and/or first purifying catalyst body and/or the temperature of said hydrogen gas, and further a reference temperature is set for a temperature detected by said temperature detection part so that when the detected temperature is lower than said reference temperature, said second oxidizing gas supply part is stopped and said first oxidizing gas supply part is operated, and when the detected temperature is not less than said reference temperature, said first oxidizing gas supply part is stopped and said second oxidizing gas supply part is operated.
